(19) United States
(12) Patent Application Publication
(10) Pub. No.: US 2012/0183338 A1
(43) Pub. Date: Jul. 19, 2012

(54) DEBURRING DEVICE, RECORDING-MEDIUM SUPPLY DEVICE, AND IMAGE FORMING APPARATUS

(75) Inventor: Yusuke KANAI, Kanagawa (JP)

(73) Assignee: FUJI XEROX CO., LTD., Tokyo (JP)

(21) Appl. No.: 13/214,335

(22) Filed: Aug. 22, 2011

(30) Foreign Application Priority Data
Jan. 18, 2011 (JP) 2011-007606

(51) Int. Cl. G03G 15/00; B26D 1/12

(52) U.S. Cl. 399/361; 83/663

(57) ABSTRACT

A deburring device includes a first contact member that rotates in contact with a first end of a transported recording medium in a width direction, a second contact member that rotates in contact with a second end of the transported recording medium in the width direction, a press member that presses the transported recording medium toward the first and second contact members, and a pushing member that produces a pressing force such that the recording medium is pressed between the first and second contact members and the press member. The first contact member and the second contact member are arranged to pull the recording medium outward in the width direction of the recording medium during rotation.

### CROSS-REFERENCE TO RELATED APPLICATION

This application is based on and claims priority under 35 USC 119 from Japanese Patent Application No. 2011-007606 filed Jan. 18, 2011.

### BACKGROUND

The present invention relates to a deburring device, a recording-medium supply device, and an image forming apparatus.

### SUMMARY

According to an aspect of the invention, there is provided a deburring device including a first contact member that rotates in contact with a first end of a transported recording medium in a width direction; a second contact member that rotates in contact with a second end of the transported recording medium in the width direction; a press member that presses the transported recording medium toward the first and second contact members; and a pushing member that produces a pressing force such that the recording medium is pressed between the first and second contact members and the press member. The first contact member and the second contact member are arranged to pull the recording medium outward in the width direction during rotation.

### BRIEF DESCRIPTION OF THE DRAWINGS

Exemplary embodiments of the present invention will be described in detail based on the following figures, wherein:

FIG. 1 is a perspective view of a recording-medium supply device according to a first exemplary embodiment of the present invention;

FIG. 2 is a perspective view of a deburring device according to the first exemplary embodiment of the present invention;

FIG. 3 is a perspective view of the deburring device of the first exemplary embodiment;

FIG. 4 is a plan view of the recording-medium supply device of the first exemplary embodiment;

FIG. 5 is a plan view of the recording-medium supply device of the first exemplary embodiment;

FIG. 6 is a plan view of the recording-medium supply device of the first exemplary embodiment;

FIG. 7 is a perspective view of the recording-medium supply device of the first exemplary embodiment;

FIG. 8 is a structural view of an image forming unit provided in an image forming apparatus according to the first exemplary embodiment of the present invention;

FIG. 9 is a schematic structural view of the image forming apparatus of the first exemplary embodiment;

FIG. 10 is a perspective view of a recording-medium supply device according to a second exemplary embodiment of the present invention;

FIG. 11 is a plan view of the recording-medium supply device of the second exemplary embodiment;

FIG. 12 is a plan view of the recording-medium supply device of the second exemplary embodiment; and

FIG. 13 is a perspective view of a deburring device according to a third exemplary embodiment of the present invention.

### DETAILED DESCRIPTION

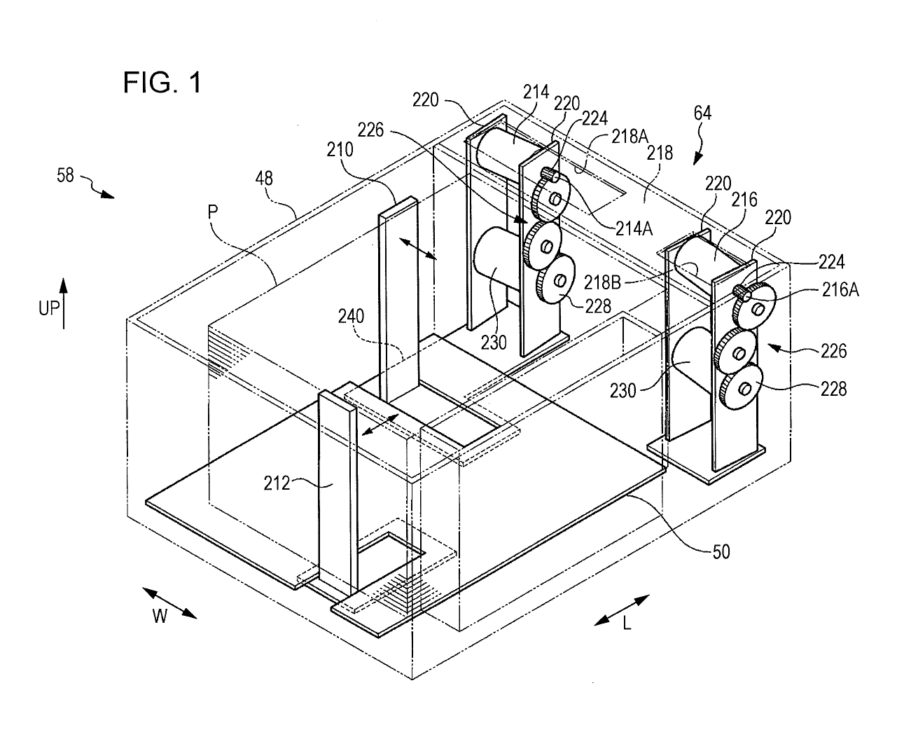

A deburring device, a recording-medium supply device, and an image forming apparatus according to a first exemplary embodiment of the present invention will be described with reference to FIGS. 1 to 9. In these figures, arrow “UP” indicates a vertical upward direction.

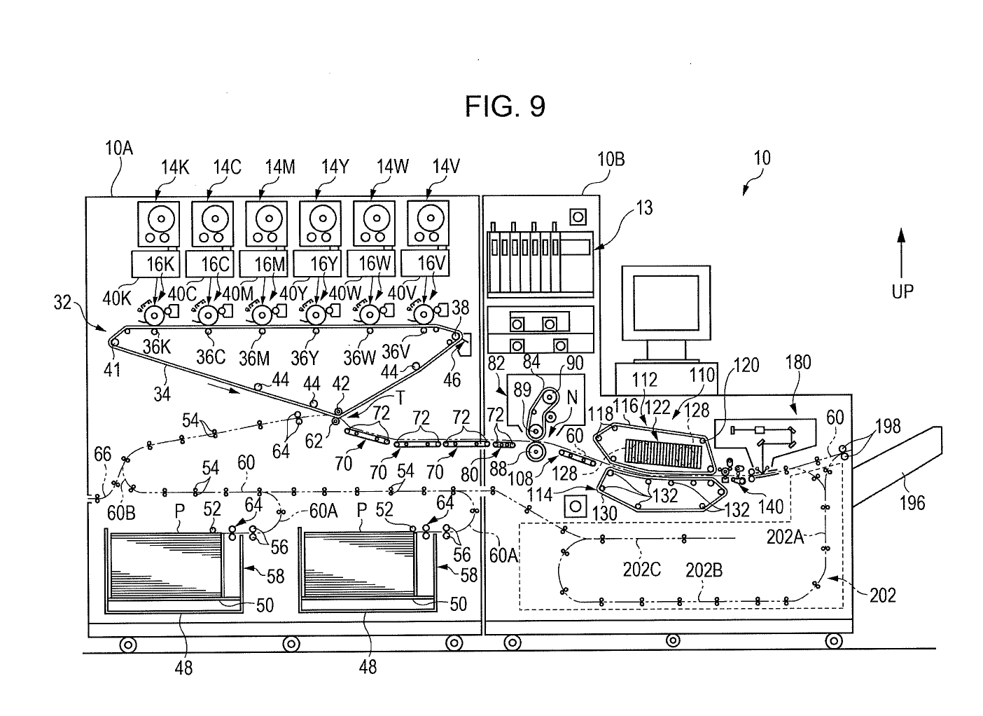

An image forming apparatus 10 according to the first exemplary embodiment forms a full-color image or a monochrome image. As illustrated in FIG. 9, the image forming apparatus 10 includes a first housing 10A, and a second housing 10B detachably connected to the first housing 10A. The first housing 10A stores a first processing section that forms one side part in the horizontal direction (left side in FIG. 9). The second housing 10B stores a second processing section that forms the other side part in the horizontal direction (right side in FIG. 9).

In an upper part of the second housing 10B, an image signal processing unit 13 is provided to conduct image processing on image data sent from an external apparatus such as a computer.

In contrast, in an upper part of the first housing 10A, toner cartridges 14B, 14W, 14Y, 14M, 14C, and 14K that respectively store toners of a first special color (V), a second special color (W), yellow (Y), magenta (M), cyan (C), and black (K) are interchangeably arranged in the horizontal direction.

The first special color and the second special color are appropriately selected from colors (including a clear color) different from yellow, magenta, cyan, and black. In the following, components that are common to each of the first special color (V), the second special color (W), yellow (Y), magenta (M), cyan (C), and black (K), are described with letters V, W, Y, M, C, and K representing the colors appended to the reference numerals. When the first special color (V), the second special color (W), yellow (Y), magenta (M), cyan (C), and black (K) are not distinguished, the letters V, W, Y, M, C, and K are omitted.

Below the toner cartridges 14, six image forming units 16 are arranged in the horizontal direction in correspondence with the toner cartridges 14 containing the color toners.

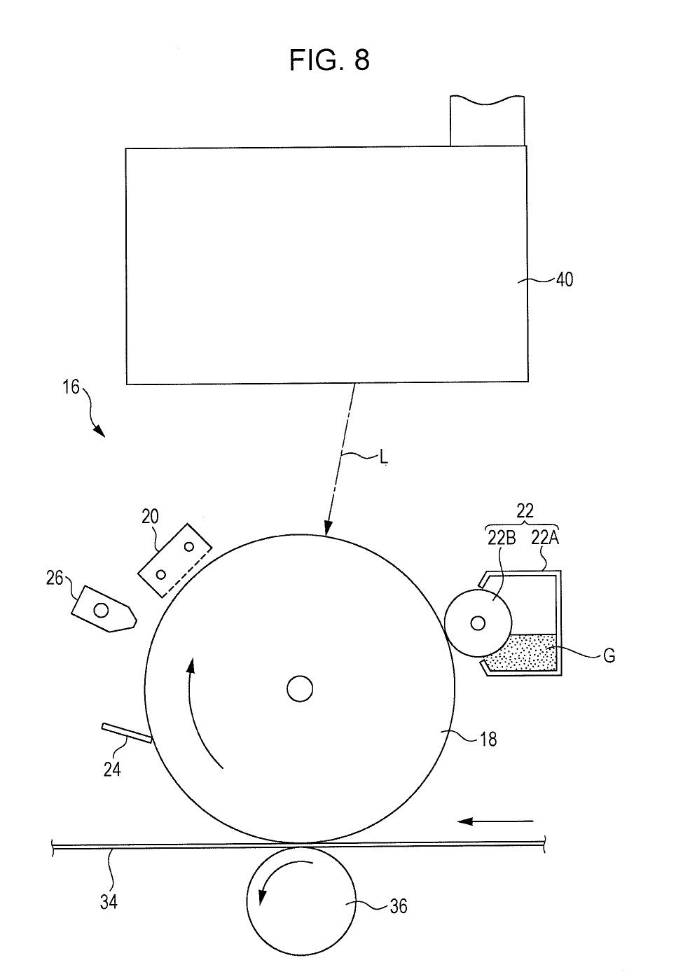

An exposure device 40 is provided in each of the image forming units 16. The exposure device 40 receives processed image data from the image signal processing unit 13, and applies a light beam L modulated according to the image data onto a below-described image carrier 18 (see FIG. 8).

As illustrated in FIG. 8, each image forming unit 16 includes an image carrier 18 to be rotated in one direction (a clockwise direction in FIG. 8). The image carrier 18 is irradiated with a light beam L from the corresponding exposure device 40 to form an electrostatic latent image thereon.

Around the image carrier 18, a scorotron charger 20, a developing device 22, a blade 24, and a charge eliminating device 26 are arranged. The scorotron charger 20 is of a corona discharge type (non-contact charge type) that charges the image carrier 18. The developing device 22 develops an electrostatic latent image, which is formed on the image carrier 18 by the exposure device 40, with developer. The blade 24 functions as a removal member that removes developer remaining on the image carrier 18 after transfer. The charge eliminating device 26 irradiates the image carrier 18 with light after transfer so as to eliminate the charge.

The scorotron charger 20, the developing device 22, the blade 24, and the charge eliminating device 26 are arranged in this order from the upstream side toward the downstream side in a rotating direction of the image carrier 18 while opposing a surface of the image carrier 18.

The developing device 22 includes a developer storage member 22A that stores developer G containing toner, and a developing roller 22B that supplies the developer G from the developer storage member 22A onto the image carrier 18. The developer storage member 22A is connected to the toner cartridge 14 (see FIG. 9) by a toner supply path (not illustrated) so that toner is supplied from the toner cartridge 14 into the developer storage member 22A.

As illustrated in FIG. 9, a transfer section 32 is provided below the image forming units 16. The transfer section 32 includes a looped intermediate transfer belt 34 in contact with all image carriers 18, and primary transfer rolls 36 serving as primary transfer members that transfer multiple toner images formed on the image carriers 18 onto the intermediate transfer belt 34.

The intermediate transfer belt 34 is stretched around a driving roll 38 to be driven by an unillustrated motor, a tensioning roll 41 that applies tension to the intermediate transfer belt 34, an opposing roll 42 opposing a below-described secondary transfer roll 62, and plural winding rolls 44. The intermediate transfer belt 34 is circulated by the driving roll 38 in one direction (a counterclockwise direction in FIG. 9).

Each primary transfer roll 36 opposes the image carrier 18 in the corresponding image forming unit 16 with the intermediate transfer belt 34 being disposed therebetween. To the primary transfer roll 36, a transfer bias voltage having a polarity opposite the toner polarity is applied from a power supply unit (not illustrated), so that a toner image formed on the image carrier 18 is transferred onto the intermediate transfer belt 34.

On a side of the intermediate transfer belt 34 opposite the driving roll 38, a removal device 46 is provided to remove residual toner or paper dust on the intermediate transfer belt 34 with a blade in contact with the intermediate transfer belt 34.

Below the transfer section 32, two recording-medium supply devices 58 are arranged in the horizontal direction. The recording-medium supply devices 58 store recording media such as paper sheets.

Each of the recording-medium supply devices 58 includes a recording-medium stack portion 48 in which sheet materials P are stacked as recording media. The recording-medium stack portion 48 is drawable from the first housing 10A. Further, at one upper end (right side in FIG. 9) of the recording-medium stack portion 48, a feed roll 52 is provided to feed out a sheet material P from the recording-medium stack portion 48 toward a transport path 60.

A bottom plate 50 on which the sheet materials P are stacked is also provided in the recording-medium stack portion 48. When the recording-medium stack portion 48 is drawn out from the first housing 10A, the bottom plate 50 moves down according to instructions from a controller (not illustrated). This downward movement of the bottom plate 50 forms, in the recording-medium stack portion 48, a space that allows the user to resupply sheet materials P.

The drawn recording-medium stack portion 48 is loaded in the first housing 10A, the bottom plate 50 moves up according to instructions from the controller. When the bottom plate 50 moves up, the uppermost one of the sheet materials P on the bottom plate 50 comes into contact with the feed roll 52.

On a downstream side of the feed roll 52 in a recording-medium transport direction (hereinafter sometimes simply referred to as a downstream side), a deburring device 64 is provided to remove burrs formed on a sheet material P fed out from the recording-medium stack portion 48. Details of the recording-medium supply device 58 will be described below.

On the downstream side of the recording-medium supply device 58, separation rolls 56 are provided to separate sheet materials P double fed from the recording-medium stack portion 48 one by one. On the downstream side of the separation rolls 56, plural transport rolls 54 are provided as an example of a transport member that transports the sheet material P downstream in the transport direction.

The transport path 60 provided between the recording-medium stack portions 48 and the transfer section 32 extends to a transfer position T (an example of an image forming portion) between the secondary transfer roll 62 and the opposing roll 42 so that the sheet material P fed out from each recording-medium supply device 58 is turned to the left side in FIG. 9 at a first turning portion 60A and is further turned to the right side in FIG. 9 at a second turning portion 60B.

A transfer bias voltage having a polarity opposite the toner polarity is applied from the power supply unit (not illustrated) to the secondary transfer roll 62, whereby the secondary transfer roll 62 secondarily transfers multiple color toner images transferred on the intermediate transfer belt 34 onto the sheet material P that has been transported along the transport path 60.

An auxiliary path 66 extends from a side surface of the first housing 10A to join the second turning portion 60B of the transport path 60. A sheet material P fed out from another recording-medium storage unit (not illustrated) provided adjacent to the first housing 10A enters the transport path 60 through the auxiliary path 66.

On the downstream side of the transfer position T, plural transport belts 70 are provided in the first housing 10A so as to transport a sheet material P, on which a toner image is transferred, toward the second housing 10B. In the second housing 10B, a transfer belt 80 is provided to transport the sheet material P from the transport belts 70 to the downstream side.

Each of the transport belts 70 and 80 is looped and is wound around a pair of winding rolls 72. The winding rolls 72 are arranged on the upstream and downstream sides of the sheet material P in the transport direction. One of the winding rolls 72 rotates to circulate the transport belt 70 (transport belt 80) in one direction (a counterclockwise direction in FIG. 9).

On the downstream side of the transfer belt 80, a fixing unit 82 is provided to fix the transferred toner image on the sheet material P with heat and pressure.

The fixing unit 82 includes a fixing belt 84, and a pressure roller 88 that is in contact with the fixing belt 84 from below. A fixing portion N at which the toner image is fixed by pressurizing and heating the sheet material P is provided between the fixing belt 84 and the pressure roller 88.

The fixing belt 84 is looped, and is wound around a driving roll 89 and a driven roller 90. The driving roll 89 opposes the pressure roller 88 from above, and the driven roller 90 is located above the driving roll 89.

The driving roll 89 and the driven roller 90 each incorporate a heating portion, such as a halogen heater, which heats the fixing belt 84.

As illustrated in FIG. 9, on the downstream side of the fixing unit 82, a transport belt 108 is provided to transport the sheet material P from the fixing unit 82 to the further downstream side. The transport belt 108 is formed similarly to the transport belts 70.

On the downstream side of the transport belt 108, a cooling unit 110 is provided to cool the sheet material P heated by the fixing unit 82.

The cooling unit 110 includes an absorption device 112 that absorbs heat from the sheet material P, and a pressing device 114 that presses the sheet material P against the absorption device 112. The absorption device 112 is located on one side of the transport path 60 (upper side in FIG. 9), and the pressing device 114 is located on the other side (lower side in FIG. 9).

The absorption device 112 includes a looped absorption belt 116 in contact with the sheet material P so as to absorb heat from the sheet material P. The absorption belt 116 is wound around a driving roll 120 for transmitting driving force to the absorption belt 116, and plural winding rolls 118.

On an inner peripheral side of the absorption belt 116, a heatsink 122 formed of an aluminum material is provided. The heatsink 122 dissipates the absorbed heat from the absorption belt 116 while being in planar contact therewith.

A fan 128 is provided on a backside of the second housing 10B (backside of the plane of FIG. 9) so as to take heat from the heat sink 122 and to discharge the heat.

The pressing device 114 for pressing the sheet material P against the absorption device 112 includes a looped pressing belt 130 that transports the sheet material P while pressing the sheet material P against the absorption belt 116. The pressing belt 130 is wound around plural winding rolls 132.

On the downstream side of the cooling unit 110, a correction device 140 is provided to correct curl of the sheet material P by pressing and transporting the sheet material P.

On the downstream side of the correction device 140, a detection device 180 is provided to detect a toner concentration defect, an image defect, an image position defect, etc. of a toner image fixed on the sheet material P.

The detection device 180 detects a toner concentration defect, an image defect, an image position defect, etc. by detecting light, which is emitted from a light source to the sheet material P and is reflected upward by the sheet material P, with a detection element such as a charge coupled device (CCD) image sensor.

On the downstream side of the detection device 180, output rolls 198 are provided to output the sheet material P having one image-formed surface into an output portion 196 attached to a side surface of the second housing 10B.

To form images on both surfaces, the sheet material P coming out of the detection device 180 is transported to a reverse path 202 provided downstream of the detection device 180.

The reverse path 202 includes a branch path 202A branching from the transport path 60, a sheet transport path 202B through which the sheet material P transported along the branch path 202A is transported toward the first housing 10A, and a reverse path 202C that switches back the sheet material P transported along the sheet transport path 202B in an opposite direction so that the sheet material P is turned upside down.

With this structure, the sheet material P switched back by the reverse path 202C is transported toward the first housing 10A, passes through the transport path 60 provided above the recording-medium stack portions 48, and is then transported to the transfer position T again.

Next, a description will be given of an image forming process performed in the image forming apparatus 10.

Image data subjected to image processing by the image signal processing unit 13 is sent to the exposure devices 40. In each of the exposure devices 40, a light beam L is emitted according to the image data and is applied onto the image carrier 18 charged by the scorotron charger 20, thereby forming an electrostatic latent image.

As illustrated in FIG. 8, the electrostatic latent image formed on each image carrier 18 is developed by the developing device 22. Thus, toner images of the first special color (V), the second special color (W), yellow (Y), magenta (M), cyan (C), and black (K) are formed on the photoconductors 28 in the image forming units 16V, 16W, 16Y, 16M, 16C, and 16K, respectively.

As illustrated in FIG. 9, the color toner images formed on the photoconductors 28 are sequentially transferred onto the intermediate transfer belt 34 by the six primary transfer rolls 36V, 36W, 36Y, 36M, 36C, and 36K.

The multiple color toner images transferred on the intermediate transfer belt 34 are secondarily transferred by the secondary transfer roll 62 onto a sheet material P transported from any of the recording-medium stack portions 48. The sheet material P on which the toner images are transferred is transported by the transport belts 70 toward the fixing unit 82 provided in the second housing 10B.

The color toner images are fixed on the sheet material P with heat and pressure in the fixing unit 82. Further, the sheet material P on which the toner images are fixed is cooled while passing through the cooling unit 110, and is then transported into the correction device 140, where it is corrected for curl.

The sheet material P corrected for curl is subjected to detection of an image defect or the like in the detection device 180, and is output to the output portion 196 by the output rolls 198.

In contrast, to form an image on a back surface of the sheet material P (no-image surface) on which an image is not formed (duplex printing), the sheet material P is reversed by the reverse path 202 after passing through the detection device 180, and is transported into the transport path 60 provided above the recording-medium stack portions 48, where a toner image is formed on the back surface in the above-described procedure.

In the image forming apparatus 10 of the first exemplary embodiment, the components for forming images of the first and second special colors (image forming units 16V and 16W, exposure devices 40V and 40W, toner cartridges 14V and 14W, and primary transfer rolls 36V and 36W) may be selectively mounted by the user as additional components in the first housing 10A. Therefore, the image forming apparatus 10 may have a structure in which components for forming images of the first and second special colors are not provided, or a structure in which only a component for forming an image of any one of the first and second special colors is provided.

Next, the recording-medium supply devices 58 will be described.

As illustrated in FIG. 1, each recording-medium supply device 58 includes the box-shaped recording-medium stack portion 48 in which sheet materials P are stacked, as described above. In the recording-medium stack portion 48, the bottom plate 50 is provided such that the sheet materials P are placed thereon.

A side guide 210 is provided movably relative to the recording-medium stack portion 48 in a width direction of sheet materials P (a direction of arrow W in FIG. 1, hereinafter sometimes simply referred to as a width direction). The side guide 210 is an example of an aligning member that aligns sheet materials P stacked in the recording-medium stack portion 48 in the width direction by contacting with the sheet materials P from one side in the width direction.

An end guide 212 is provided movably relative to the recording-medium stack portion 48 in a longitudinal direction of the sheet materials P (a direction of arrow L in FIG. 1). The end guide 212 aligns the sheet materials P stacked in the recording-medium stack portion 48 in the longitudinal direction by contacting with rear edges of the sheet materials P. The side guide 210 and the end guide 212 are movable in slits provided in the bottom plate 50.

The deburring device 64 is provided at a leading end of the recording-medium stack portion 48 in the longitudinal direction of the sheet materials P (an end from which a sheet material P is fed out). The deburring device 64 removes a burr formed on the sheet material P fed out from the recording-medium stack portion 48. A burr formed on the sheet material P refers to a projection formed in a thickness direction of the sheet material P at an edge of the sheet material P when the sheet material P is cut.

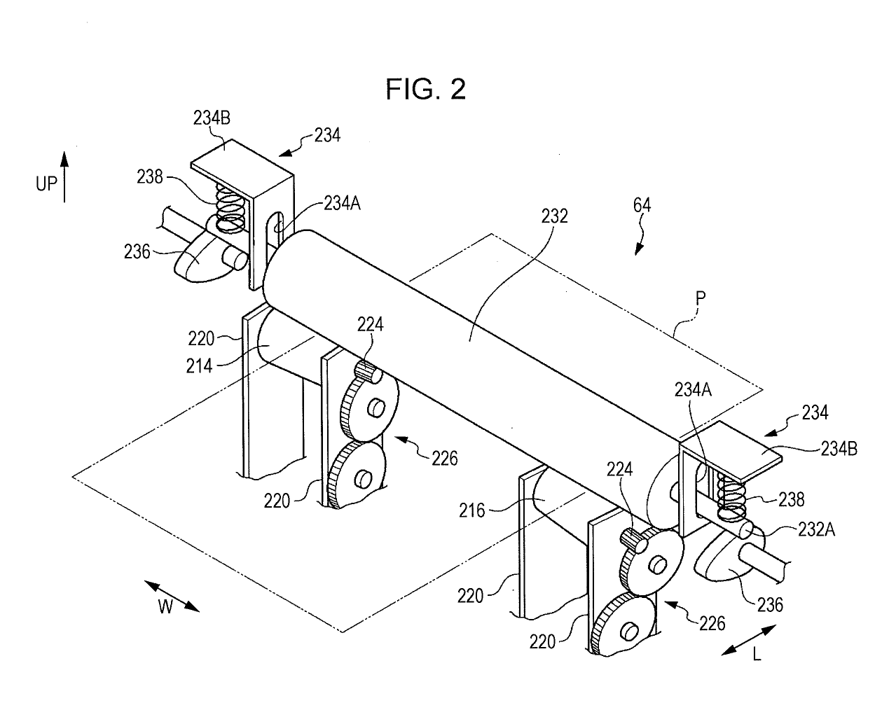

As illustrated in FIGS. 1 and 2, the deburring device 64 includes a first roll 214 and a second roll 216. The first roll 214 serves as an example of a first contact member that rotates in contact with one end in the width direction of a sheet material P fed out from the recording-medium stack portion 48. The second roll 216 serves as an example of a second contact member that rotates in contact with the other end in the width direction of the sheet material P.

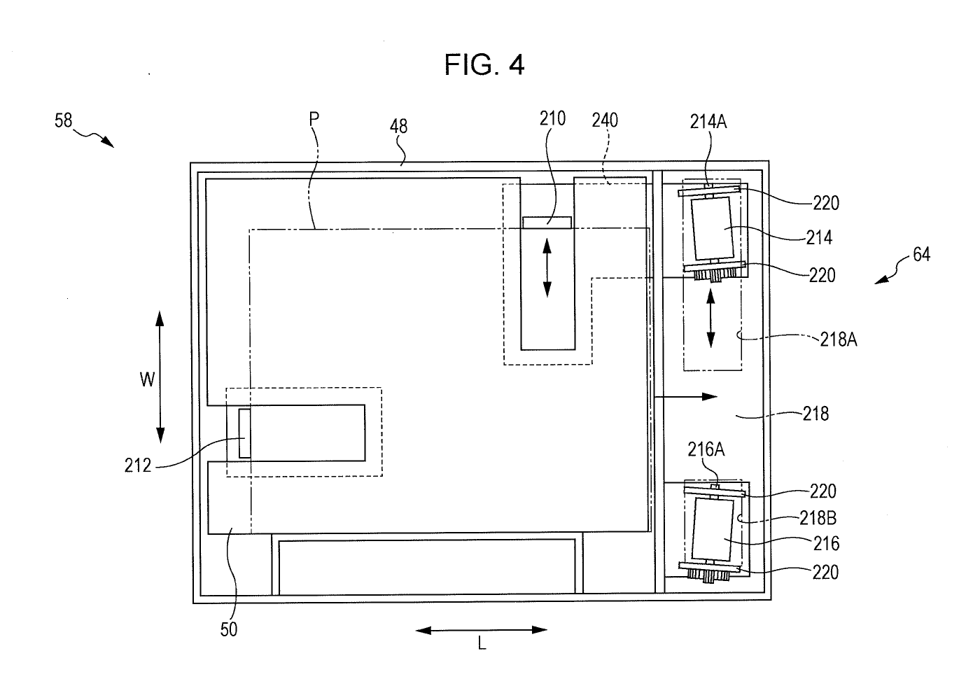

As illustrated in FIG. 4, the first roll 214 and the 216 are arranged to pull the sheet material P from the recording-medium stack portion 48 outward in the width direction in plan view (as viewed from above).

More specifically, a rotation shaft 214A of the first roll 214 and a rotation shaft 216A of the second roll 216 tilt with respect to the width direction of the sheet material P from an inner side to an outer side in the width direction and from the downstream side to the upstream side in the transport direction of the sheet material P. Further, upper ends of the first roll 214 and the second roll 216 project out from apertures 218A and 218B provided in a cover plate 218 at an upper end of the recording-medium stack portion 48.

As illustrated in FIGS. 1 and 2, the rotation shaft 214A of the first roll 214 and the rotation shaft 216 of the second roll 216 are each rotatably supported at both ends by platelike support members 220 extending in the up-down direction. The rotation shaft 214A and the rotation shaft 216A are each provided with a gear 224 at one end. A gear train 226 is rotatably attached to the support member 220 at the one end, and is meshed with the gear 224.

A rotation shaft of the lowermost gear 228 in the gear train 226 is provided with a motor 230 serving as a driving source. When the motor 230 is driven, rotational force is transmitted from the motor 230 to the corresponding one of the first roll 214 and the second roll 216 via the gear train 226.

As illustrated in FIG. 2, an opposing roll 232 is provided above the first roll 214 and the second roll 216 in a manner such as to oppose the first roll 214 and the second roll 216. The opposing roll 232 serves as an example of a press member that presses a sheet material P between the opposing roll 232 and the first and second rolls 214 and 216. A rotation shaft 232A of the opposing roll 232 extends in the width direction of the sheet material P.

Inverse-L-shaped support members 234 are provided at opposite ends of the rotation shaft 232A of the opposing roll 232, and are fixed to the first housing 10A (see FIG. 9). The opposite ends of the rotation shaft 232A of the opposing roll 232 extend through vertical slots 234A provided in the support members 234 such that the rotation shaft 232A is movable in the slots 234A.

Cams 236 serving as an example of a shift member to be rotated by driving force are provided at opposite ends of the opposing roll 232 in the longitudinal direction. The end portions of the rotation shaft 232A protruding from the slots 234A are supported by outer peripheral surfaces of the cams 236 from below.

Between folded portions 234B of the support members 234 folded outward and the rotation shaft 232A, compression springs 238 are provided in a compressed manner as an example of a pushing member that pushes the opposing roll 232 toward the first roll 214 and the second roll 216.

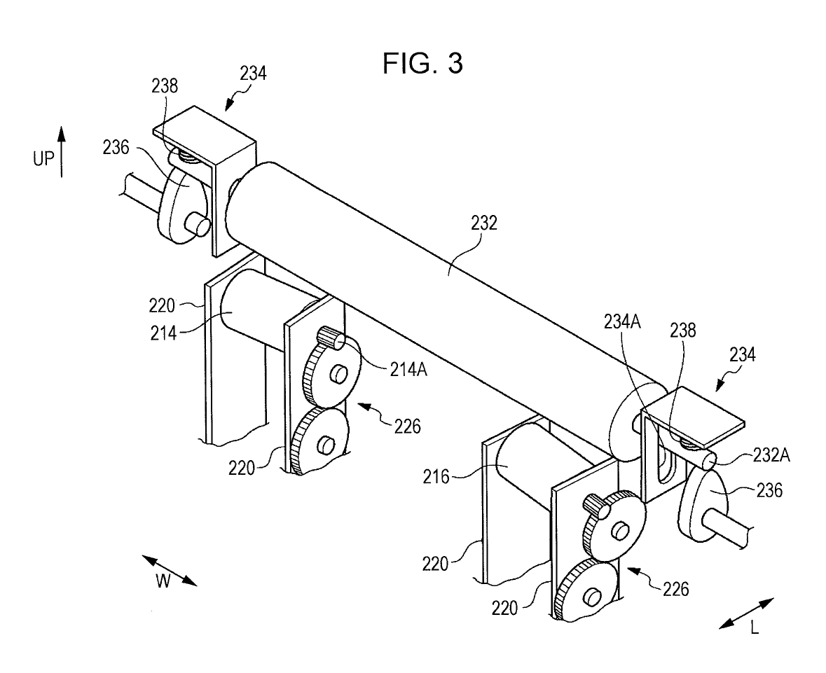

With this structure, when the rotation shaft 232A of the opposing roll 232 is supported by outer peripheral faces of short-diameter portions of the cams 236, it separates from the cams 236, and the opposing roll 232 is placed at a pressing position to press the first roll 214 and the second roll 216 (see FIG. 2). In contrast, when the cams 236 are turned according to instructions from the unillustrated controller so that the rotation shaft 232A of the opposing roll 232 is supported by outer peripheral faces of long-diameter portions of the cams 236, the position of the opposing roll 232 is shifted from the pressing position to a separate position separate from the first roll 214 and the second roll 216 (see FIG. 3).

From the above, the deburring device 64 includes the first roll 214, the second roll 216, the opposing roll 232, the compression springs 238, and the cams 236 as major components.

As illustrated in FIG. 1, a connecting member 240 serving as an example of an interlock member is provided on a lower side of the bottom plate 50 so as to connect lower ends of the support members 220 to which the first roll 214 is attached, to a lower end of the side guide 210.

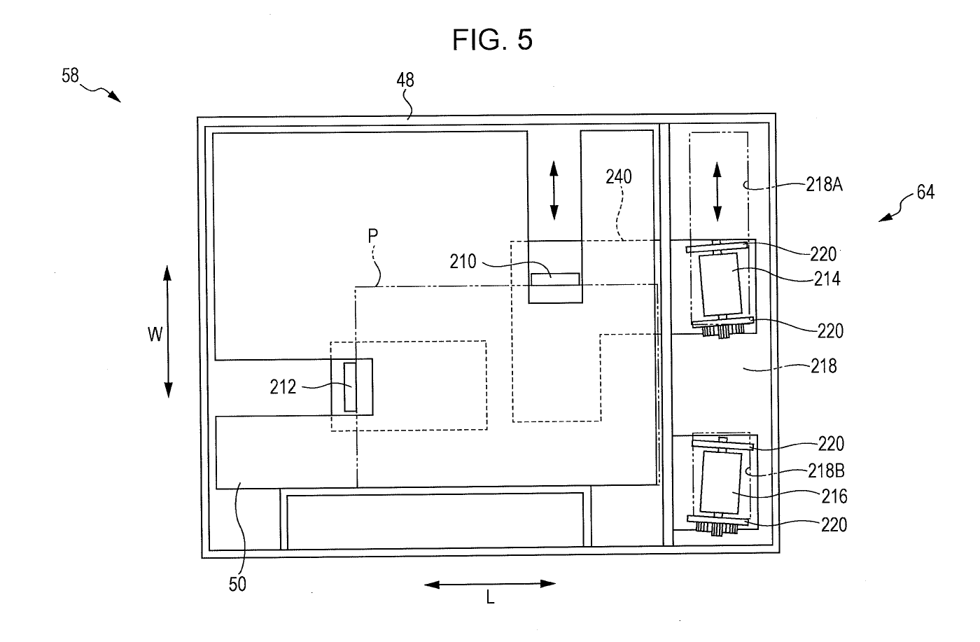

Thus, as illustrated in FIGS. 4 and 5, the connecting member 240 moves the first roll 214, in conjunction with movement of the side guide 210, to a position such that the first roll 214 and the second roll 216 come into contact with the ends of the sheet material P in the width direction.

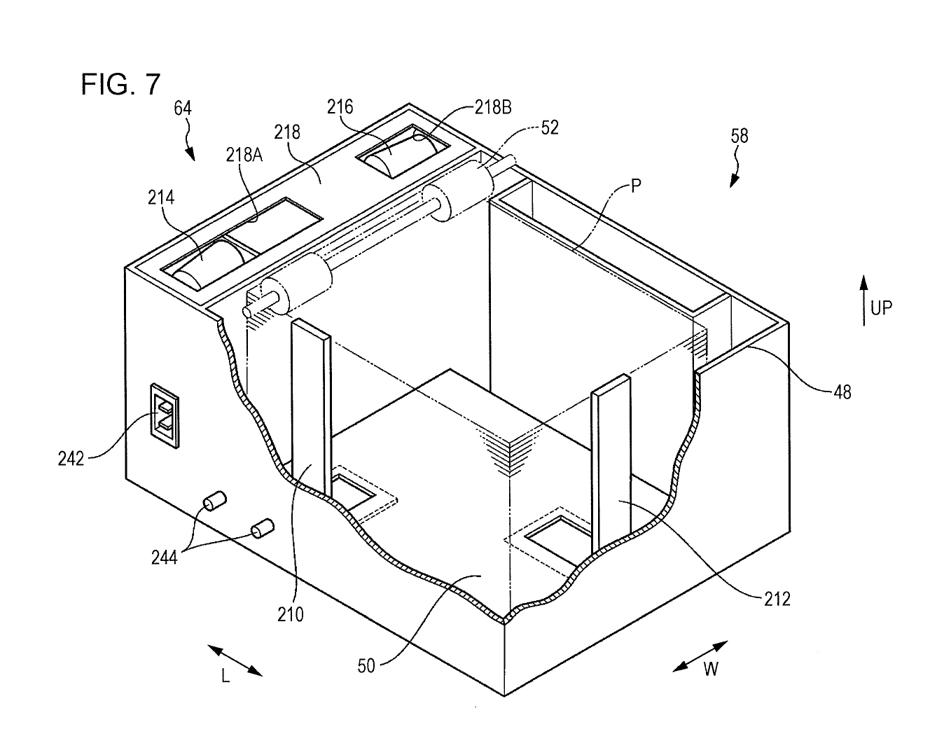

As illustrated in FIG. 7, a connector 242 is provided on a back surface of the recording-medium stack portion 48 (a surface facing toward the backside when the recording-medium stack portion 48 is mounted in the first housing 10A). The connector 242 is to be connected to a connector (not illustrated) fixed to the first housing 10A so as to supply electric power to each motor 230 (see FIG. 1).

Further, two projecting positioning pins 244 are provided on the back surface of the recording-medium stack portion 48 so that the connector 242 is guided to a connecting position with the connector of the first housing 10A. The positioning pins 244 are to be fitted in recesses provided in the first housing 10A when the recording-medium stack portion 48 is mounted in the first housing 10A. That is, this structure defines a mounting position of the recording-medium stack portion 48 in the first housing 10A, and efficiently connects the connector 242 to the connector fixed to the first housing 10A.

From the above, the recording-medium supply device 58 includes the recording-medium stack portion 48, the side guide 210, the deburring device 64, and the connecting member 240 as major parts.

Next, a description will be given of the operations of the deburring device 64 and the recording-medium supply device 58 including the deburring device 64.

As illustrated in FIG. 2, when the rotation shaft 232A of the opposing roll 232 is supported by the outer peripheral faces of the short-diameter portions of the cams 236, the rotation shaft 232A separates from the cams 236, and the opposing roll 232 is placed at the pressing position to press the first roll 214 and the second roll 216.

As illustrated in FIGS. 1, 2, and 6, the rotating feed roll 52 (see FIG. 9) feeds out the uppermost one of the sheet materials P stacked in the recording-medium stack portion 48. The sheet material P fed out from the recording-medium stack portion 48 is transported further downstream while being pressed between the first and second rolls 214 and 216 and the opposing roll 232 that are rotating.

The opposing roll 232, to which pushing force is transmitted from the compression springs 238, presses the ends of the sheet material P in the width direction against an outer surface of the first roll 214 and an outer surface of the second roll 216.

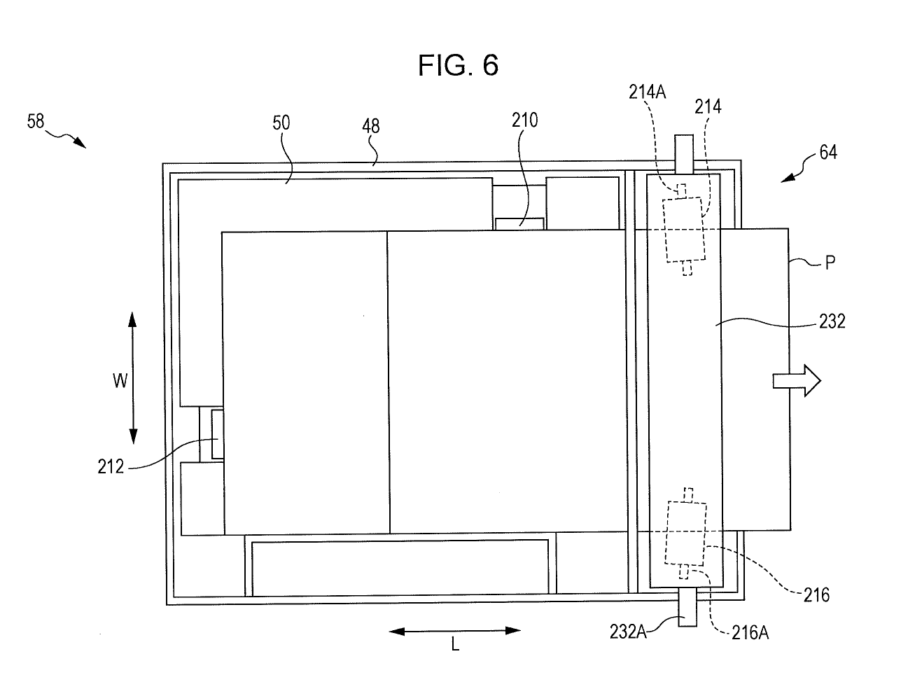

As described above, the rotation shaft 214A of the first roll 214 and the rotation shaft 216A of the second roll 216 tilt from the inner side to the outer side in the width direction of the sheet material P and from the downstream side to the upstream side in the transport direction of the sheet material P (see FIG. 6). Thus, the sheet material P is transported downstream while being pulled outward in the width direction between the first and second rolls 214 and 216 and the opposing roll 232.

As described above, when the ends of the sheet material P in the width direction are pressed against the outer surface of the first roll 214 and the outer surface of the second roll 216, burrs formed at the ends of the sheet material P in the width direction by cutting are crushed and removed (deburred).

Since the sheet material P is transported downstream while being pulled outward in the width direction, wrinkling of the sheet material P is suppressed.

By turning the cams 236 according to instructions from the unillustrated controller, the position of the opposing roll 232 is shifted from the pressing position to a separate position separate from the first roll 214 and the second roll 216 (see FIG. 3). For this reason, when there is no need to deburr the sheet material P, loads on the first roll 214 and the second roll 216 are reduced by shifting the position of the opposing roll 232 to the separate position.

Since the loads on the first roll 214 and the second roll 216 are reduced, the lives of the first roll 214 and the second roll 216 are extended.

The connecting member 240 moves the first roll 214 in conjunction with movement of the side guide 210 so that the first roll 214 and the second roll 216 contact with the ends of the sheet material P in the width direction. For this reason, wrinkling occurring in the transported sheet material P during transportation and deburring is suppressed according to the size of the sheet material P.

Since the transported sheet material P has been deburred, damage to the transport rolls 54 provided downstream of the deburring device 64 is suppressed.

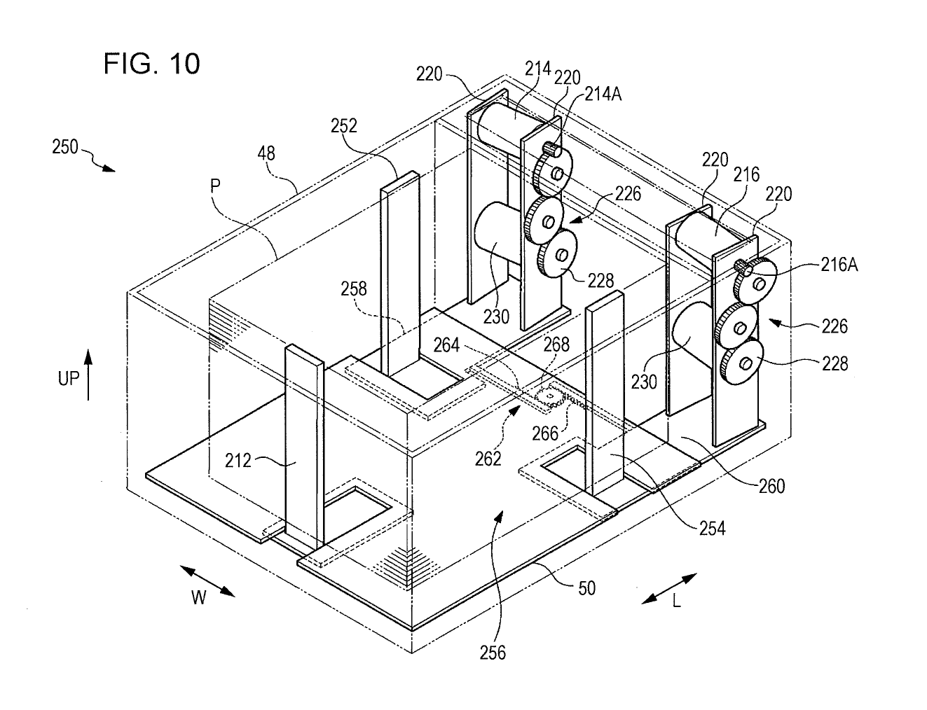

Next, a deburring device, a recording-medium supply device, and an image forming apparatus according to a second exemplary embodiment of the present invention will be described with reference to FIGS. 10 to 12. The same components as those adopted in the first exemplary embodiment are denoted by the same reference numerals, and descriptions thereof are skipped.

As illustrated in FIG. 10, a recording-medium supply device 250 of the second exemplary embodiment includes a first side guide 252 and a second side guide 254. The first side guide 252 serves as an example of an aligning member that is movable relative to a recording-medium stack portion 48 in a width direction of sheet materials P stacked in the recording-medium stack portion 48 and that aligns the sheet materials P in the width direction by contacting with the sheet materials P from one side in the width direction. The second side guide 254 serves as an example of an aligning member that is movable in the width direction of the sheet materials P stacked in the recording-medium stack portion 48 and that aligns the sheet materials P in the width direction by contacting with the sheet materials P from the other side in the width direction.

Between lower ends of the first and second side guides 252 and 254 and lower ends of support members 220 for supporting first and second rolls 214 and 216, an interlock unit 256 is provided as an example of an interlock member. The interlock unit 256 moves the first roll 214 and the second roll 216 in conjunction with movements of the first side guide 252 and the second side guide 254 so that the first roll 214 and the second roll 216 come into contact with ends of each sheet material P in the width direction.

More specifically, the interlock unit 256 includes a platelike connecting member 258 that connects the lower end of the first side guide 252 to the lower ends of the support members 220 supporting the first roll 214, a platelike connecting member 260 that connects the lower end of the second side guide 254 to the lower ends of the support members 220 supporting the second roll 216, and a rack and pinion mechanism 262 provided between the connecting member 258 and the connecting member 260.

The rack and pinion mechanism 262 includes a first rack gear 264 having a proximal end fixed to the connecting member 258 and a distal end extending toward the connecting member 260, a second rack gear 266 having a proximal end fixed to the connecting member 260 and a distal end extending toward the connecting member 258, and a pinion gear 268 provided between the first rack gear 264 and the second rack gear 266. The pinion gear 268 is rotatably attached to a bottom plate of the recording-medium stack portion 48, and is meshed with the first rack gear 264 and the second rack gear 266.

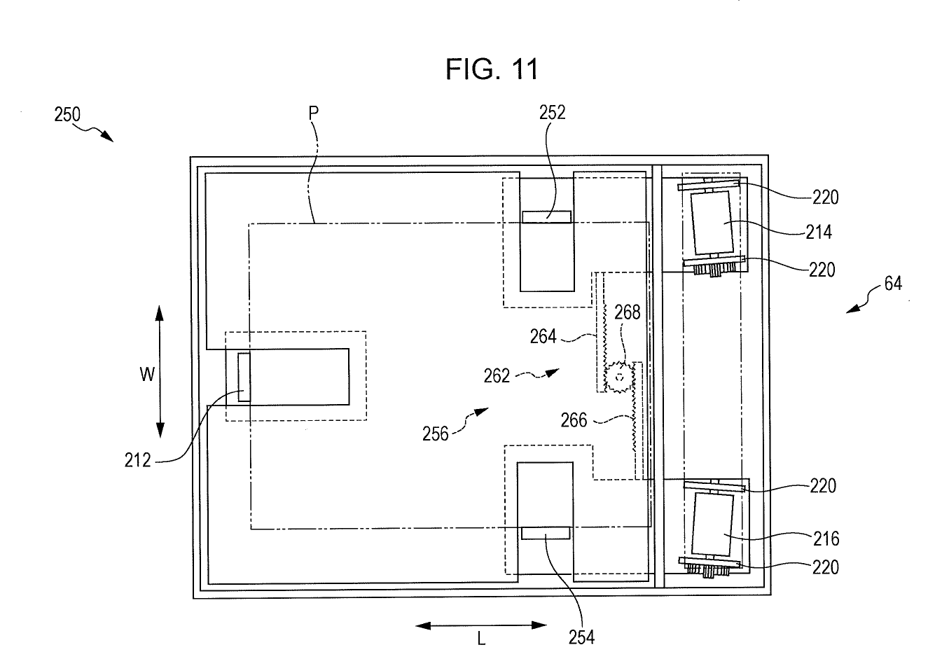

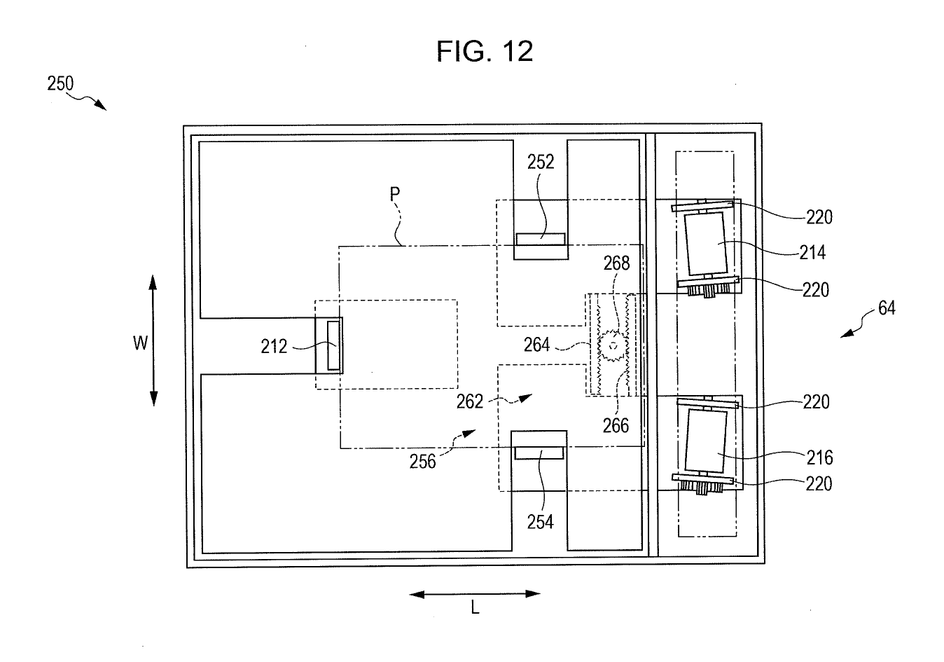

In the above-described structure, as illustrated in FIGS. 11 and 12, the interlock unit 256 moves the first roll 214 and the second roll 216 in conjunction with movements of the first side guide 252 and the second side guide 254 so that the first roll 214 and the second roll 216 come into contact with the ends of the sheet material P in the width direction.

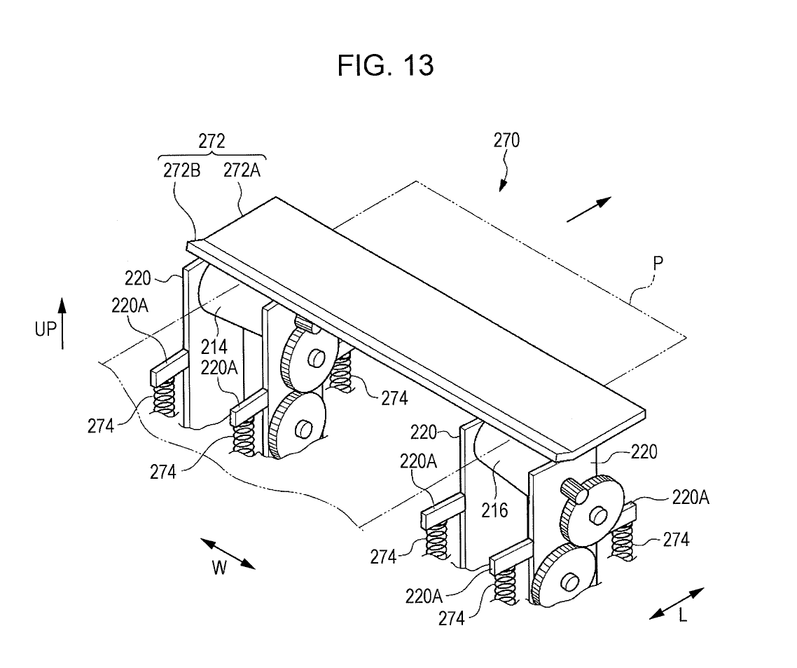

Next, a deburring device, a recording-medium supply device, and an image forming apparatus according to a third exemplary embodiment of the present invention will be described with reference to FIG. 13. The same components as those adopted in the first exemplary embodiment are denoted by the same reference numerals, and descriptions thereof are skipped.

As illustrated in FIG. 13, a deburring device 270 of the third exemplary embodiment does not include an opposing roll that presses a transported sheet material P between the opposing roll and a first roll 214 and a second roll 216. Instead, the deburring device 270 includes an opposing plate 272 serving as an example of a press member.

More specifically, the opposing plate 272 is formed by folding a flat plate. The opposing plate 272 includes a transport portion 272A that presses a transported sheet material P between the transport portion 272A and the first and second rolls 214 and 216, and a guide portion 272B that guides a leading end of the transported sheet material P into between the transport portion 272A and the first and second rolls 214 and 216.

Further, a pair of support members 220 for supporting the first roll 214 have projecting pieces 220A projecting in the transport direction of the sheet material P. To lower faces of the projecting pieces 220A, compression springs 274 are fixed at one end as an example of a pushing member that pushes the first roll 214 against the opposing plate 272 with the support members 220 being disposed therebetween.

Support members 220 for supporting the second roll 216 have a similar structure. The second roll 216 is pushed toward the opposing plate 272 by pushing forces of compression springs 274.

While the exemplary embodiments of the present invention have been described in detail, it is obvious to others skilled in the art that the present invention is not limited to these exemplary embodiments and that other various embodiments are possible within the scope of the invention. For example, while the deburring device is provided in the recording-medium supply device in the above-described first, second, and third exemplary embodiments, the deburring device does not always need to be provided in the recording-medium supply device. It is satisfactory as long as the deburring device is provided in the transport path for the sheet material P in the first housing 10A.

Further, while the motors 230 are provided to apply rotating force to the first roll 214 and the second roll 216 in the first, second, and third exemplary embodiments, it is not always necessary to apply rotating force thereto. It is only necessary that the first roll and the second roll are rotatable.

While the opposing roll 232 is separated from the first roll 214 and the second roll 216 by being moved upward in the first exemplary embodiment, the first roll and the second roll may be moved to separate from the opposing roll.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A deburring device comprising:
a first contact member that rotates in contact with a first end of a transported recording medium in a width direction;
a second contact member that rotates in contact with a second end of the transported recording medium in the width direction;
a press member that presses the transported recording medium toward the first and second contact members; and
a pushing member that produces a pressing force such that the recording medium is pressed between the first and second contact members and the press member,
wherein the first contact member and the second contact member are arranged to pull the recording medium outward in the width direction of the recording medium during rotation.

2. The deburring device according to claim 1, further comprising:
a shift member that shifts the first and the second contact members and the press member between a press position where the first and second contact members and the press member press the transported recording medium and a separate position where the first and second contact members are separate from the press member.

3. A recording-medium supply device comprising:
a recording-medium stack portion in which recording media are stacked;
an aligning member that aligns the stacked recording media by contacting with the recording media from one side or both sides in a width direction of the recording media, the aligning member being movable relative to the recording-medium stack portion in the width direction of the recording media;
The deburring device according to claim 1, the deburring device removing burrs formed at both ends in the width direction of a recording medium fed out from the recording-medium stack portion; and
an interlock member that moves at least one of the first contact member and the second contact member provided in the deburring device in conjunction with movement of the aligning member so that the first contact member and the second contact member come into contact with the ends of the recording medium in the width direction.

4. An image forming apparatus comprising:
the deburring device according to claim 1;
an image forming section that forms an image on a recording medium; and
a transport member that transports the recording medium to the image forming section from which a burr is removed by the deburring device.

5. An image forming apparatus comprising:
the recording-medium supply device according to claim 3;
an image forming section that forms an image on a recording medium; and
a transport member that transports, to the image forming section, a recording medium supplied from the recording-medium supply device.

6. The deburring device according to the claim 1, wherein the first contact member is tilted toward the first end from a transport direction of the transported recording medium, and the second contact member is tilted toward the second end from the transport direction of the transported recording medium.

7. The deburring device according to the claim 1, wherein the press member is rotatable about an axis that extends along the width direction.

8. A deburring device comprising:
a first contact member that rotates in contact with a first end of a transported recording medium in a width direction, a rotational axis of the first contact member forming an acute angle with the width direction;
a second contact member that rotates in contact with a second end of the transported recording medium in the width direction, a rotational axis of the second contact member forming an acute angle with the width direction;
a press member that presses the transported recording medium toward the first and second contact members; and
a pushing member that produces a pressing force such that the recording medium is pressed between the first and second contact members and the press member,
wherein a production line of the rotational axis of the first contact member and a production line of the rotational axis of the second contact member are arranged to form a triangle with the width direction, and an apex of the triangle is pointed toward a transporting direction.

9. The deburring device according to claim 8, further comprising:
a shift member that shifts the first and the second contact members and the press member between a press position where the first and second contact members and the press member press the transported recording medium and a separate position where the first and second contact members are separate from the press member.

10. A recording-medium supply device comprising:
a recording-medium stack portion in which recording media are stacked;
an aligning member that aligns the stacked recording media by contacting with the recording media from one side or both sides in a width direction of the recording media, the aligning member being movable relative to the recording-medium stack portion in the width direction of the recording media;
the deburring device according to claim 8, the deburring device removing burrs formed at both ends in the width direction of a recording medium fed out from the recording-medium stack portion; and
an interlock member that moves at least one of the first contact member and the second contact member provided in the deburring device in conjunction with movement of the aligning member so that the first contact member and the second contact member come into contact with the ends of the recording medium in the width direction.
